(19) United States
(12) Patent Application Publication
(10) Pub. No.: US 2009/0268253 A1
(43) Pub. Date: Oct. 29, 2009

(54) IMAGE PROCESSING APPARATUS

(75) Inventor: Takashi KUDOU, Kanagawa (JP)

Correspondence Address: YOUNG & THOMPSON, 209 Madison Street, Suite 500, ALEXANDRIA, VA, 22314, US

(73) Assignee: NEC ELECTRONICS CORPORATION, KANAGAWA (JP)

(21) Appl. No.: 12/425,652

(22) Filed: Apr. 17, 2009

(30) Foreign Application Priority Data
Apr. 24, 2008 (JP) 2008-113537

(51) Int. Cl. H04N 1/405

(52) U.S. Cl. 358/3.06

(57) ABSTRACT

An image processing apparatus receives an input image signal generated by combining a plurality of image signals with different bit precisions, and generates an output image signal obtained by increasing the number of gradation steps of the input image signal by bit extension. The image processing apparatus includes an intermediate signal generation section which generates an intermediate signal according to the input image signal. The intermediate signal corrects the input image signal such that a pixel value corresponding to a halftone added by the bit extension is included in the output image signal. The image processing apparatus further includes a nonlinear filter to perform a nonlinear process on a pixel value of the intermediate signal. The nonlinear filter changes its filter characteristic based on a pre-synthesis bit precision of a pixel that is to be processed and included in the input image signal when the nonlinear process is performed on the pixel value of the intermediate signal corresponding to the pixel to be processed.

### BACKGROUND

1. Field of the Invention

The present invention relates to an image processing apparatus for increasing the number of gradation steps of an input image signal, which is generated by combining a plurality of image signals with different bit precisions by bit extension.

2. Description of Related Art

Image processing apparatuses for increasing the number of gradation steps of digital image signals are well known. In such image processing apparatuses, one purpose is to realize smoother gradation representation at outputting the digital image signals to television sets, which have been increasingly advancing in terms of the resolution and the screen size. Other purpose of the image processing apparatus is to ensure sufficient bit precision at image processing such as gamma correction processing and contour enhancement processing is performed on the digital image signals. In order to achieve such purposes, the image processing apparatuses performs the increasing the number of gradation steps of digital image signals, and such image processing apparatuses are disclosed in Japanese Unexamined Patent Application Publication Nos. 2005-86388, 2007-221569, and 2007-213460.

An image processing apparatus which extends the bit precision of a digital image signal is hereinafter referred to as a bit extension apparatus.

The bit extension apparatus extends the bit width of an input image signal having a bit precision (i.e. the number of quantization bits) of m bits to n=m+k bits. Then the bit extension apparatus corrects the pixel value of the input image signal such that the halftones corresponding to the extended low-order k bits are included in the output image signal.

An output image signal including halftones is generated by the following procedure, for example. An input image signal, for which the bit width is extended, is smoothed to generate a smoothed signal. Then, a subtraction process is performed between the smoothed signal and the input image signal to generate a differential signal including the information about halftones. Further, a non-linear process is performed on the differential signal. After that, the differential signal is added to the smoothed signal or the input image signal whose bit width is extended, thereby producing an output image signal including halftones. Note that the nonlinear process to be carried out on the differential signal includes a coring process and a limitation process for limiting a bit width.

FIG. 12 is a block diagram illustrating a bit extension apparatus of the related art which is disclosed by Japanese Unexamined Patent Application Publication No. 2005-86388. A bit extension apparatus 9 of FIG. 12 extends an input image signal having 8-bit precision to 10-bit precision. Then the bit extension apparatus 9 generates an output image signal having 10 bit precision including halftones corresponding to the extended 2 bits. In FIG. 12, a LPF (Low Pass Filter) 91 calculates the moving average of pixel values of an input image signal in order to smooth the input image signal. The LPF 91 outputs a smoothed signal which is extended to 10 bits.

A subtractor 92 performs a subtraction process between an input image signal (to be precise, an input image signal extended to 10 bits by a bit shift operation) and a smoothed signal. That is, a differential signal obtained in the subtraction process by the subtractor 92 is a signal generated by extracting low-order bits of the smoothed signal. The differential signal includes the halftone values generated by smoothing. Note that in the configuration of FIG. 12, a signal to be added by an adder 94, which is described later, is the smoothed signal output from the LPF 91. Therefore, the subtractor 92 just needs to subtract the smoothed signal from the input image signal whose bits are extended. The differential signal obtained in the subtraction process by the subtractor 92 is supplied to a nonlinear characteristic processing section 93.

The nonlinear characteristic processing section 93 is a digital filter which performs a nonlinear coring process and a limitation process for limiting the upper limit of an output signal to a predetermined level or below. A nonlinear process by the nonlinear characteristic processing section 93 is performed on low-order bits of the differential signal including halftone values.

The adder 94 adds the differential signal, on which the nonlinear process was performed, to the smoothed signal generated by the LPF 91. An output from the adder 94 is supplied to a limiter 95. The limiter 95 imposes a limitation on the over-range bit of the output from the adder 94, and then outputs 10-bit output image signal.

Note that the specific configuration of the bit extension apparatus to perform increasing the number of gradation steps of an input signal is not limited to the configuration of the bit extension apparatus 9 of FIG. 12. The bit extension apparatus 9 performs a nonlinear process on a differential signal which is obtained by performing a subtraction between a smoothed signal and an input image signal. On the other hand, the bit extension apparatus disclosed in Japanese Unexamined Patent Application Publication No. 2007-221569 performs a nonlinear process on a smoothed signal, and then adds a differential signal to the smoothed signal in order to generate an output image signal. Further, a bit extension apparatus disclosed in Japanese Unexamined Patent Application Publication No. 2007-213460 performs a nonlinear process on a smoothed signal, and then mixes an input image signal with the smoothed signal in a predetermined mixing ratio in order to generate an output image signal. Therefore, the bit extension apparatus disclosed in Japanese Unexamined Patent Application Publication No. 2007-213460 does not generate a differential signal in contrast to the bit extension apparatus 9, and includes the data mixer instead of the adder 94.

That is, there are a lot of variations in the signal processing process for increasing the number of gradation steps of an input image signal. However, there is a common point in those various signal processing processes that an intermediate signal is generated in advance and a nonlinear process is performed on this intermediate signal so that the input image signal is corrected in such a manner that pixel values corresponding to halftones that are added by the bit extension are included in the output image signal. For example, the intermediate signal on which the bit extension apparatus 9 performs a non-linear process is a differential signal obtained in a subtraction process between an input image signal and a smoothed signal. Moreover, the intermediate signal on which the bit extension apparatuses disclosed by Japanese Unexamined Patent Application Publication No. 2007-221569 and Japanese Unexamined Patent Application Publication No. 2007-213460 perform a non-linear process is a smoothed signal obtained by smoothing an input image signal.

### SUMMARY

The present inventors have found a following problem. If an input image signal, for which the number of gradation steps is to be increased, is a synthesized image signal generated by combining a plurality of image signals with different bit precisions in an image synthesis process such as additive synthesis and transparent synthesis or the like, it is very difficult to smoothly increase the number of gradation steps of the input image signal by a bit extension apparatus of the related art such as the abovementioned bit extension apparatus 9.

This problem is explained using an example hereinafter.

FIG. 13 illustrates an example of an input image signal which is generated by combining a plurality of image signals with different bit precisions. An area A (white area) of FIG. 13 is an area of a background image, and has a bit precision W2 before the image synthesis. On the other hand, an area B (shaded area) of FIG. 13 is an area of an OSD (On Screen Display) image, and has a bit precision W1 before the image synthesis Note that W2 is assumed to be larger than W1 by k bits. Furthermore, after the image synthesis, the input image signal is assumed to have a bit width of W2 bits, i.e. This W2 bits is the same bit width as the background image, and a larger bit precision than W1.

When the number of gradation steps of an input image signal is to be increased, a bit extension apparatus of the related art performs a common nonlinear process on the entire area of the input image signal according to the bit width of the input image signal. Therefore, if an input image signal 96 of FIG. 13 is supplied to the bit extension device of the related art, bits are not sufficiently extended for the area B, which has the lower bit precision before the image synthesis, thereby causing unnatural tone jumps in the output image signal. This problem is explained with reference to FIGS. 14(a) to 14(c).

FIGS. 14(a) to 14(c) are examples of the input image signal 96 illustrated in FIG. 13. In FIGS. 14(a) to 14(c), a bit precision W1 of area B is 8 bits, a bit precision W2 of area A is 10 bits, and an output image signal whose bits are extended by a bit extension apparatus is 12 bits. FIG. 14(a) illustrates a distribution of gradation values of the input image signal 96. Before the image synthesis, the area B of the input image signal 96 has a bit precision of 8 bits, which is smaller than that of the area A by 2 bits. Accordingly, before the image synthesis, a width of a 1-LSB (Least Significant Bit) of the area B, which is an 8-bit signal, is four times as long as a 1-LSB width of the area A, which is a 10 bit signal. Therefore, the gradation values which the pixels of the area B can take are values at every 4 gradations as shown as gradation values A, A+4, A+8, A+4, A+12, and so forth in FIGS. 14(a) to 14(c).

As shown in FIG. 14(b), when the pixels of the area B are extended to be 12 bits, a nonlinear output limitation process, which allows a pixel values change of the input image signal within a range of 4 bits (i.e., 16 gradation steps), i.e. should be performed. Here, 4 bits corresponds to the difference between the bit precision W1 (8 bits) and the bit precision W3 (12 bits).

However, since the bit width of the input image signal 96 is W2 (10 bits), the bit extension apparatus of the related art can perform only an output limitation process common to the areas A and B. Accordingly, the output limitation process performed by the bit extension apparatus of the related art on the pixels of the area B is a process that allows a pixel values change of the input image signal within a range of 2 bits (i.e., 4 gradation steps), i.e. 2 bits corresponds to the difference between the bit precision W2 (10 bits) and the bit precision W3 (12 bits), as illustrated in FIG. 14(c). Therefore, gradation steps ranges R1 to R5, which are indicated by shaded areas in FIG. 14(c), are not included in the area B after the bit extension, thereby causing an unnatural tone jumps in the output image signal.

A first exemplary aspect of an embodiment of the present invention is an image processing apparatus that receives an input image signal generated by combining a plurality of image signals with different bit precisions and generates an output image signal obtained by increasing the number of gradation steps of the input image signal by bit extension. The image processing apparatus includes an intermediate signal generator generating an intermediate signal according to the input image signal, the intermediate signal being used to correct the input image signal such a manner that a pixel value corresponding to a halftone increased by the bit extension is included in the output image signal, and a nonlinear filter that performs a nonlinear process to a pixel value of the intermediate signal. Wherein, the nonlinear filter changes its filter characteristic based on a pre-synthesis bit precision of a pixel that is to be processed and included in the input image signal when the nonlinear process is performed on the pixel value of the intermediate signal corresponding to the pixel to be processed.

A second exemplary aspect of an embodiment of the present invention is an image processing apparatus including a smoother, a bit extender, a subtractor, a nonlinear filer, and an adder. The smoother generate a smoothed signal by smoothing an input image signal generated by combining a plurality of image signals with different bit precisions. The bit extender extends a bit width of the input image signal. The subtractor performs a subtraction process between the input image signal whose bits are extended by the bit extender and the smoothed signal in order to generate a differential signal. The nonlinear filter performs a nonlinear process on a pixel value of the differential signal. The adder adds one of two signals on which the subtraction process was performed and the differential signal on which the nonlinear process was performed in order to generate an output image signal. Further, the nonlinear filter changes its filter characteristic based on a pre-synthesis bit precision of a pixel that is to be processed and included in the input image signal when the nonlinear process is performed on the pixel value of the differential signal corresponding to the pixel to be processed.

The abovementioned image processing apparatus according to a first exemplary aspect of the present invention can change the filter characteristic of the nonlinear filter for performing a nonlinear process on an intermediate signal according to a pre-synthesis bit precision of a pixel that is to be processed and included in the input image signal. Similarly, the image processing apparatus according to a second exemplary aspect of the present invention can change the filter characteristic of the nonlinear filter for performing a nonlinear process on the differential signal including a halftone generated by the smoothing according to a pre-synthesis bit precision of a pixel that is to be processed and included in the input image signal. Therefore, the image processing apparatuses according to a first and a second exemplary aspect of the present invention can use different filter characteristics for areas having different bit precisions in an input image signal on an area-by-area basis depending on pre-synthesis bit precisions of the respective areas. Accordingly, the image processing apparatuses can suppress the occurrence of tone jumps, which is explained with reference to FIGS. 14(a) to 14(c), in order to generate an output image signal with smoothly increased number of gradation steps.

When the number of gradation steps of an input image signal which is generated by combining a plurality of image signals with different bit precisions is to be increased, the present invention enables to suppress the occurrence of tone jumps which is explained with reference to FIGS. 14(a) to 14(c), thereby generating an output image signal with smoothly increased number of gradation steps.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram of a bit extension apparatus according to a first exemplary embodiment of the present invention;

FIG. 2A illustrates an example of a response characteristic of a non-linear limiter included in the bit extension apparatus according to the first exemplary embodiment of the present invention;

FIG. 2B illustrates an example of a response characteristic of a non-linear limiter included in the bit extension apparatus according to the first exemplary embodiment of the present invention;

FIG. 3A illustrates an example of a response characteristic of a non-linear limiter included in the bit extension apparatus according to the first exemplary embodiment of the present invention;

FIG. 3B illustrates an example of a response characteristic of a non-linear limiter included in the bit extension apparatus according to the first exemplary embodiment of the present invention;

FIG. 4A illustrates an example of a response characteristic of a nonlinear limiter included in the bit extension apparatus according to the first exemplary embodiment of the present invention;

FIG. 4B illustrates an example of a response characteristic of a non-linear limiter included in the bit extension apparatus according to the first exemplary embodiment of the present invention;

FIG. 5 is a block diagram illustrating another configuration example of the bit extension apparatus according to the first exemplary embodiment of the present invention;

FIG. 6 is a block diagram of an alpha blender which generates an input image signal and a bit precision identification signal;

FIG. 7 is a flowchart illustrating a generation procedure of a bit precision identification signal by the alpha blender;

FIG. 8 is a block diagram of a bit extension apparatus according to a second exemplary embodiment of the present invention;

FIG. 9 is a flowchart illustrating the content of the process by a bit precision evaluator included in the bit extension apparatus according to the second exemplary embodiment of the present invention;

FIG. 10 illustrates an example of an evaluation table which is referenced by the bit precision evaluator;

FIG. 11 is a graph explaining a statistical bit precision evaluation procedure by the bit precision evaluator;

FIG. 12 is a block diagram illustrating a bit extension apparatus of a related art;

FIG. 13 illustrates an example of a synthesized image signal which includes a plurality of image signals with different bit precisions; and

FIG. 14 explains a problem in the bit extension apparatus of a related art.

### DETAILED DESCRIPTION OF THE EXEMPLARY EMBODIMENTS

Specific embodiments incorporating the present invention are described in detail with reference to the drawings. In the drawings, identical components are denoted by the same reference numerals. In the interest of clarity, the explanation will not be repeated as necessary.

### First Exemplary Embodiment

A bit extension apparatus 1 according to a first exemplary embodiment adopts a similar signal processing process to the bit extension apparatus 9, which is disclosed by Japanese Unexamined Patent Application Publication No. 2005-86388, in order to increase the number of gradation steps of an input image signal. Specifically, in order to generate a differential signal D3 including halftones equivalent to a post-bit-extension 1-LSB (Least Significant Bit), the bit extension apparatus 1 performs a subtraction process between an input image signal D1 whose bits were extended and a smoothed signal D2 obtained by smoothing a input image signal S1. Then, the bit extension apparatus 1 performs a nonlinear process on the differential signal D3, adds the post-nonlinear-process differential signal D4 and the post-bit-extension input image signal D1 in order to generate an output image signal S2.

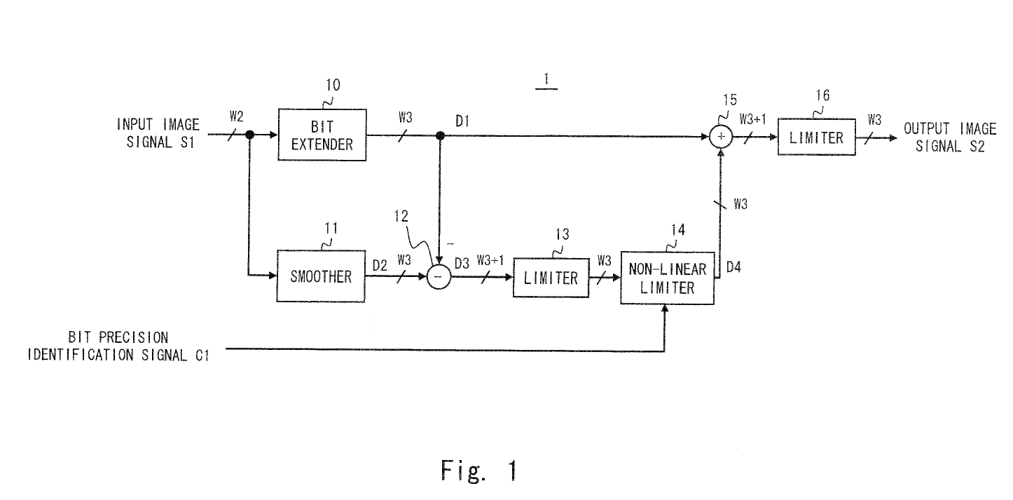

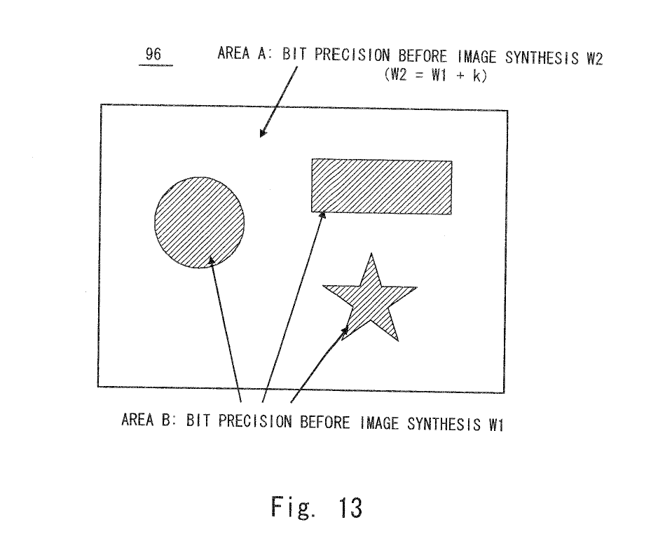

FIG. 1 is a block diagram illustrating an example of the configuration of the bit extension apparatus 1. Note that in the explanation of this embodiment, the input image signal S1 is a synthesized signal, in which an area having a pre-synthesis bit precision W1 and an area having a pre-synthesis bit precision W2 are mixed, as with the input image signal 96 of FIG. 13.

In FIG. 1, a bit extender 10 extends the input image signal S1 having the number of quantization bits of W2 bits to W3 bits by a bit shift operation.

A smoother 11 smoothes the input image signal S1 and outputs a smoothed signal D2 having the number of quantization bits of W3 bits. For example, the smoother 11 may calculates an average pixel value of processing target pixel and an average pixel value of predetermined number of pixel located around this process target pixel. Subsequently, the smoother 11 may use a moving average filter correcting pixel value of the processing target pixel with using the average pixel value. Furthermore, the smoother 11 may smooth data by other known smoothing methods such as a weighted average method instead of the moving average method.

The subtractor 12 subtracts the input image signal D1 whose bits are extended by the bit extender 10 from the smoothed signal D2 to generate the differential signal D3. In the example of FIG. 1, with the negative expression, the bit width of the differential signal D3 is W3+1 bits. The differential signal D3 is a signal produced by extracting the halftone value generated in the data smoothing process by the smoother 11. The differential signal D3 is used as a correction signal for correcting pixel values of the input image signal D1 whose bits were extended.

A limiter 13 imposes a limitation on an over-range bit which is generated in the subtraction process by the subtractor 12, and then supplies the differential signal D3 whose bit width is limited to W3 bits to a non-linear limiter 14.

The nonlinear limiter 14 is a digital filter which performs a nonlinear process on the differential signal D3. The nonlinear limiter 14 changes filter characteristics at nonlinear process of the differential signal D3 in response to a bit precision identification signal C1. Specific examples of the filter characteristics of the nonlinear limiter 14 are described later in detail.

The bit precision identification signal C1 indicates a difference of a pre-synthesis bit precision for each pixel of the input image signal S1. In the case of this exemplary embodiment, the bit precision identification signal C1 may only indicate that the pre-synthesis bit precision is either W1 or W2. Alternatively, the bit precision identification signal C1 may indicate the pre-synthesis bit precision itself.

The adder 15 adds the bit-extended input signal to the differential signal D4 which has been through nonlinear process. Lastly, a limiter 16 imposes a limitation on the over-range bit generated in the addition, and outputs an output image signal S2 whose bit width is limited to W3 bits.

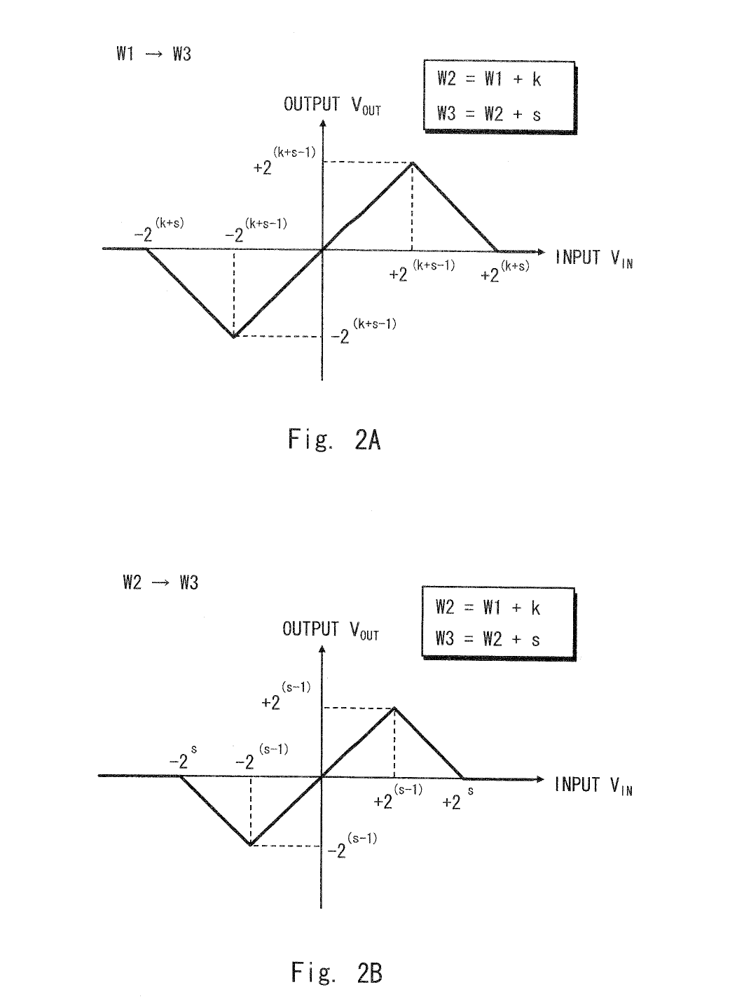

A specific example of the filter characteristic of the nonlinear limiter 14 is explained hereinbelow. FIGS. 2A and B are graphs illustrating an example of the filter characteristics of the nonlinear limiter 14. FIG. 2A illustrates a filter characteristic applied to the nonlinear limiter 14 if the pre-synthesis bit precision of a pixel to be processed is W1 (area B in FIG. 13). On the other hand, FIG. 2B illustrates a filter characteristic applied to the nonlinear limiter 14 if a pre-synthesis bit precision of a pixel to be processed is W2 (area A in FIG. 13).

With the filter characteristic of FIG. 2A, when an absolute value of the value Vᵢₙ of the input differential signal D3 is less than or equal to 2^{(k+s-1)}, the input value Vᵢₙ becomes the output value Vₒᵤₜ without any change. Further, when the absolute value of Vᵢₙ is larger than 2^{(k+s-1)} and less than or equal to 2^{(k+s)}, the output value Vₒᵤₜ is calculated by subtracting the input value from 2^{(k+s)}. Moreover, when the absolute value of Vᵢₙ is larger than 2^{(k+s)}, the output value Vₒᵤₜ becomes 0. The “k” bit here is a difference between the bit width W2 of the input image signal S1 and the bit precision W1 of a pixel to be processed. The “s” bit is the difference between the bit width W3 of the post-bit-extension output image signal S2 and the bit width W2 of the input image signal S1. The filter characteristics of FIG. 2A can be expressed by the following formulas.

V_{OUT}=V_{IN}(0<=|V_{IN}|<=2^{k+s-1})

V_{OUT}=2^{k+s}−V_{IN}(2^{k+s-1}<|V_{IN}|<=2^{k+s})

V_{OUT}=0(|V_{IN}|>2^{k+s})

On the other hand, the overall behavior of the filter characteristic of FIG. 2B, which is applied when the pre-synthesis bit precision of a pixel to be processed is W2 (area A of FIG. 13), is the same as the filter characteristic of FIG. 2A. However, due to the difference in the pre-synthesis bit precision of pixels to be processed, the output limitation range of the non-linear limiter 14 differs between FIGS. 2B and 2A. The filter characteristics of FIG. 2B can be expressed by the following formulas.

V_{OUT}=V_{IN}(0<=|V_{IN}|<=2^{s})

V_{OUT}=2^{s}−V_{IN}(2^{s-1}<|V_{IN}|<=2)

V_{OUT}=0(|V_{IN}|>2^{s})

That is, with correcting the post-bit-extension input image signal D1 using the differential signal D4 processed by the filter characteristic of FIG. 2A, the pixel value of an input image signal can be corrected within 1-LSB range in total, i.e., 0.5-LSB above and below the pre-synthesis bit precision “W1”. On the other hand, with correcting the post-extension input image signal D1 using the differential signal D4 processed by the filter characteristic of FIG. 2B, the pixel value of an input image signal can be corrected within 1-LSB range in total, i.e., 0.5-LSB above and below the pre-synthesis bit precision “W2”.

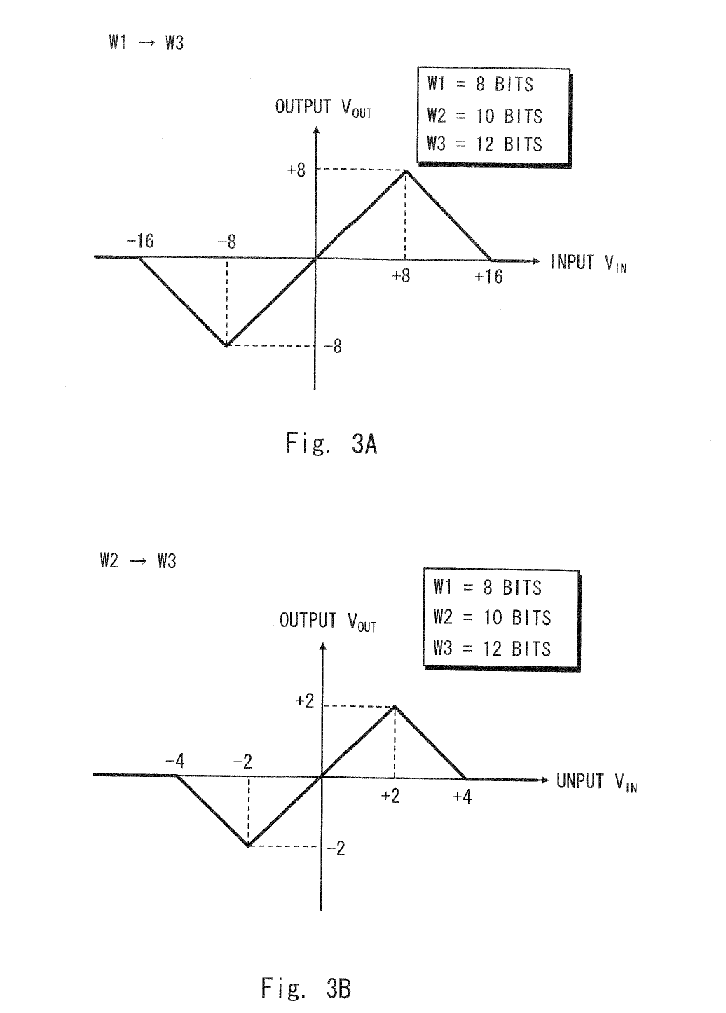

FIGS. 3A and 3B explain the difference between FIGS. 2A and 2B with specific values. The graphs of FIGS. 3A and 3B represent the filter characteristics of FIGS. 2A and 2B when W1=8 bits, W2=10 bits and W3=12 bits.

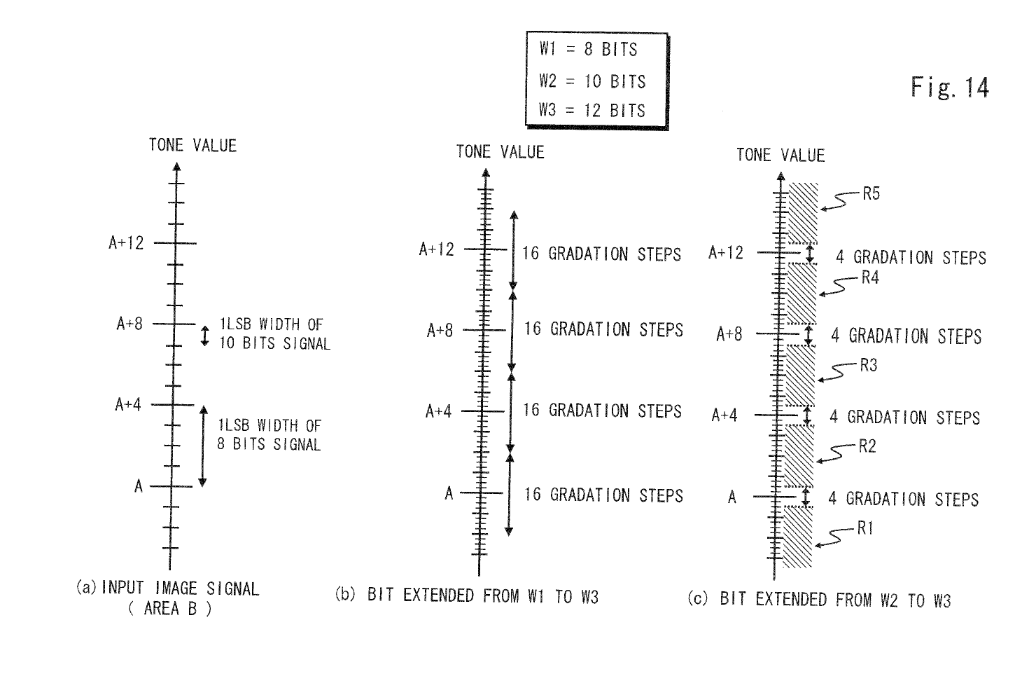

By using the filter characteristic of FIG. 3A, the pixel value of the input image signal S1 can be corrected within 1-LSB range in total, i.e., 0.5-LSB above and below the pre-synthesis bit precision W1=8 bits, that is within the range after the bits are extended to W3 bits, i.e., 2⁴=16 gradation steps range. This corresponds to the desirable correction range if the pre-synthesis bit precision is 8 bits as illustrated in FIG. 14(b).

On the other hand, by using the filter characteristic of FIG. 3B, the pixel value of the input image signal S1 can be corrected within 1-LSB range in total, i.e., 0.5-LSB above and below the pre-synthesis bit precision W1=8 bits. That is, the pixel value of the input image signal S1 can be corrected within the range after the bits are extended to W3 bits, i.e., 2²=4 gradation steps range. This corresponds to the desirable correction range when the pre-synthesis bit precision is 10 bits as illustrated in FIG. 14(c).

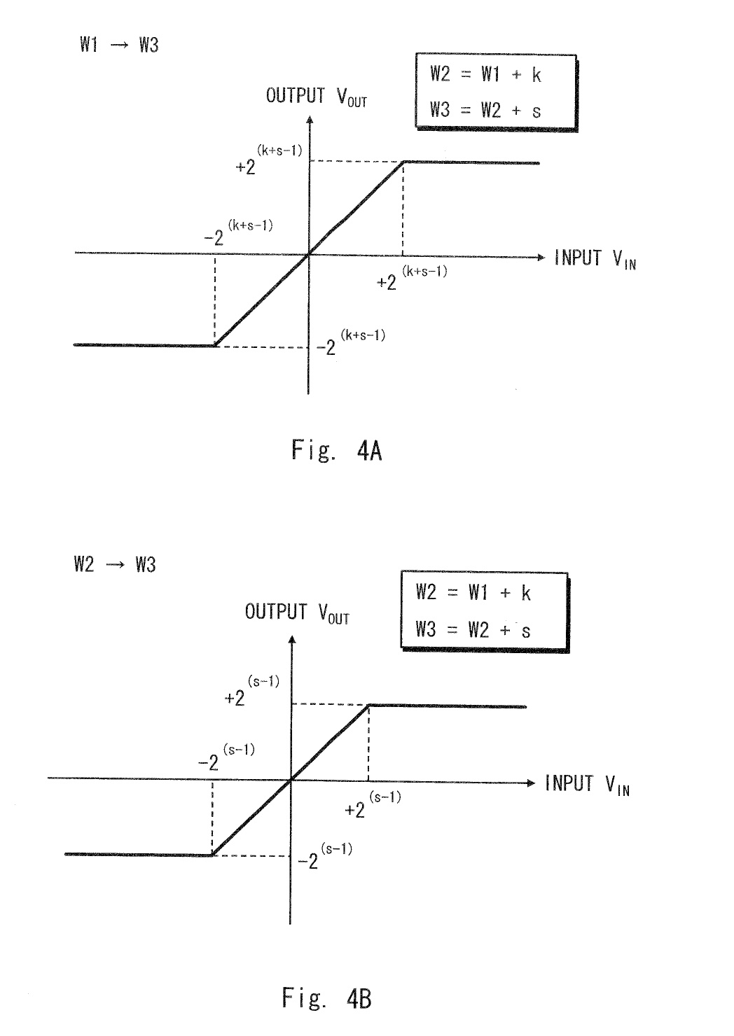

Needless to say, the filter characteristics shown in FIGS. 2A, 2B, 3A and 3B are merely examples. For example, the filter characteristics illustrated in FIGS. 4A and 4B may be used instead of FIGS. 2A and 2B. When the absolute value of the value Vᵢₙ of the differential signal D3 is larger than 2^{(k+s)} or 2^{s}, the abovementioned filter characteristics of FIGS. 2A and 2B set the filter output Vₒᵤₜ to be 0. By doing so, the pixel value of the input image signal will not be corrected at all. On the other hand, when the absolute value of the value Vᵢₙ of the differential signal D3 is larger than 2^{(k+s)} or 2^{s}, the filter characteristics of FIGS. 4A and 4B set the filter output Vₒᵤₜ to be the maximum value of the output limitation range.

As mentioned above, at increasing the steps of gradation of the input image signal, which is generated by combining a plurality of image signals with different bit precisions, the bit extension apparatus 1 of this embodiment changes the filter characteristics of the nonlinear limiter 14 according to the pre-synthesis bit precision. That is, the bit extension apparatus 1 can selectively apply a filter characteristic corresponding to the bit precision of each area of the pre-synthesis input image signal S1. Therefore, the bit extension apparatus 1 can prevent the occurrence of tone jumps in the output image signal S2, which is explained with reference to FIGS. 14(a) to 14(c).

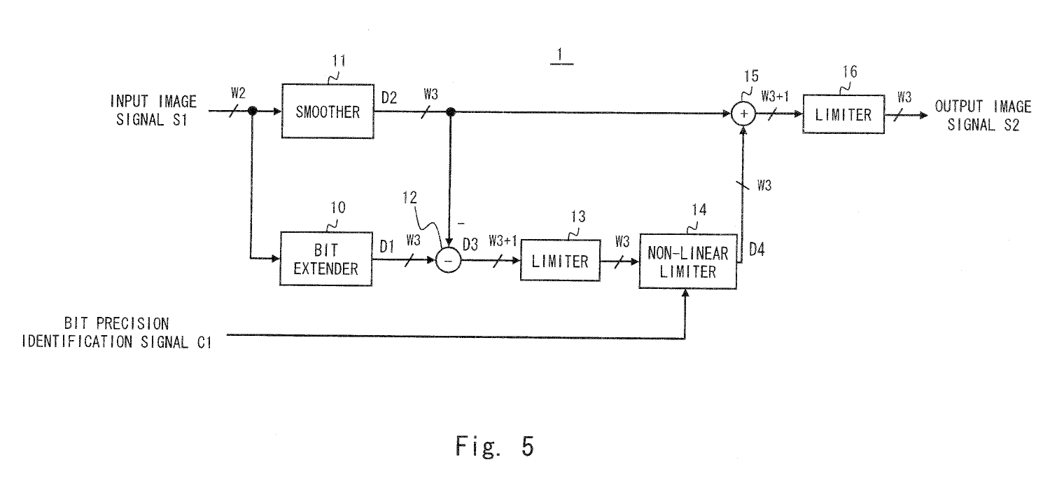

By the way, as mentioned in the background section, there are a lot of variations in the signal processing process performed on the input image signal S1 in order to generate the output image signal S2 with increased the steps of gradation. For example, the configuration of the bit extension apparatus 1 illustrated in FIG. 1 may be modified to the configuration illustrated in FIG. 5.

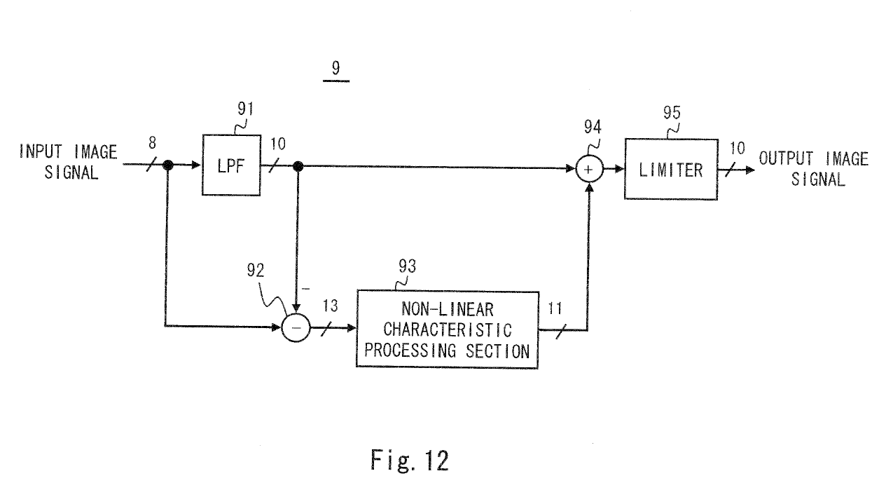

The configuration example of the bit extension apparatus 1 illustrated in FIG. 1 subtracts the post-bit-extension input image signal D1 from the smoothed signal D2 in order to generate the differential signal D3, and then adds the post-nonlinear-process differential signal D4 to the post-bit-extension input image signal D1. On the other hand, the modification of FIG. 5 differs from the configuration example of FIG. 1 in the subtraction direction of the post-bit-extension input image signal D1 and the smoothed signal D2. That is, the modified example of FIG. 5 subtracts the smoothed signal D2 from the post-bit-extension input image signal D1 to generate the differential signal D3. Further, along with the change in the subtraction direction, the modified example of FIG. 5 is modified so as to add the post-nonlinear-process differential signal D4 after to the smoothed signal D2. That is, the signal processing process by the configuration of FIG. 5 is the same as the signal processing process of the bit extension apparatus 9 of the related art illustrated in FIG. 12.

In the configuration examples of FIGS. 1 and 5, a signal that is to be processed by the nonlinear filter, the nonlinear limiter 14 is used as the differential signal D3. However, when the number of gradation steps is increased by the signal processing process as disclosed by Japanese Unexamined Patent Application Publication Nos. 2007-221569 and 2007-213460, the smoothed signal D3 obtained by smoothing the input image signal S1 is used as the signal to be processed by the non-linear filter. Accordingly, when the number of gradation steps is increased by the signal processing process as disclosed by Japanese Unexamined Patent Application Publication Nos. 2007-221569 and 2007-213460, the filter characteristics of nonlinear process for the smoothed signal D2, instead of for the differential signal D3, may be changed according to the pre-synthesis bit precision of the input image signal S1.

### Specific Example of an Image Synthesizer

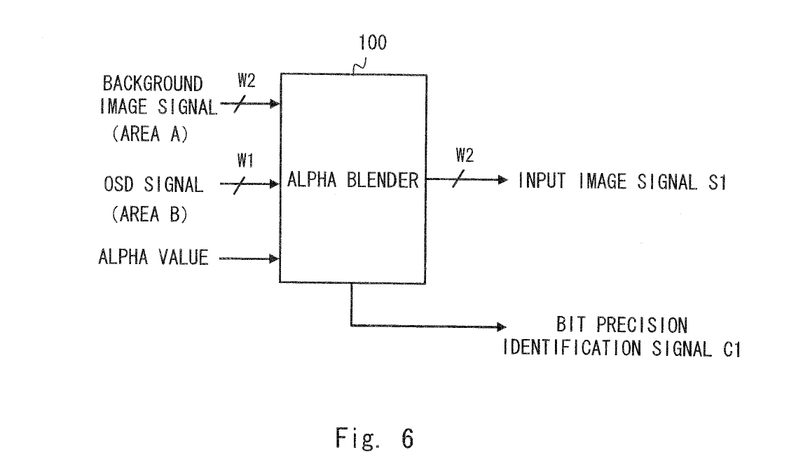

Next, an image synthesizer 100, which is an example of a generation source of the bit precision identification signal C1, is explained hereinafter. FIG. 6 is a block diagram of the image synthesizer 100. The image synthesizer 100 combines a plurality of image signals by an alpha blending process to generate the input image signal S1 which is supplied to the bit extension apparatus 1.

The image synthesizer 100 receives the background signal V1 corresponding to the area A of input image signal shown in FIG. 13, the OSD signal V2 corresponding to the area B of input image signal shown in FIG. 13, and alpha values representing the opacity of a background image signal V2, which is overlapped with the background image signal V1. The image synthesizer 100 performs the so-called transparent synthesis by the following arithmetic expression.

S1=V1×(1−alpha)+V2×alpha

The generation procedure of the bit precision identification signal C1 by the image synthesizer 100 is explained hereinafter. The image synthesizer 100 determines whether each pixel included in the input image signal S1 is close to the background image signal V1 or to the OSD signal V2 according to the alpha value, which is the parameter for determining the opacity at the time of the alpha blending. In other words, the image synthesizer 100 determines whether the pixel is mainly composed of the background image signal V1 or of the OSD signal V2. Then, if the image synthesizer 100 determines that the background image signal V1 is the main component, it outputs an identification signal C1 which indicates that the background image signal V1 is the main component. On the other hand, if the image synthesizer 100 determines that the OSD signal V2 is the main component, the image synthesizer 100 outputs an identification signal C1 which indicates that the OSD signal V2 is the main component.

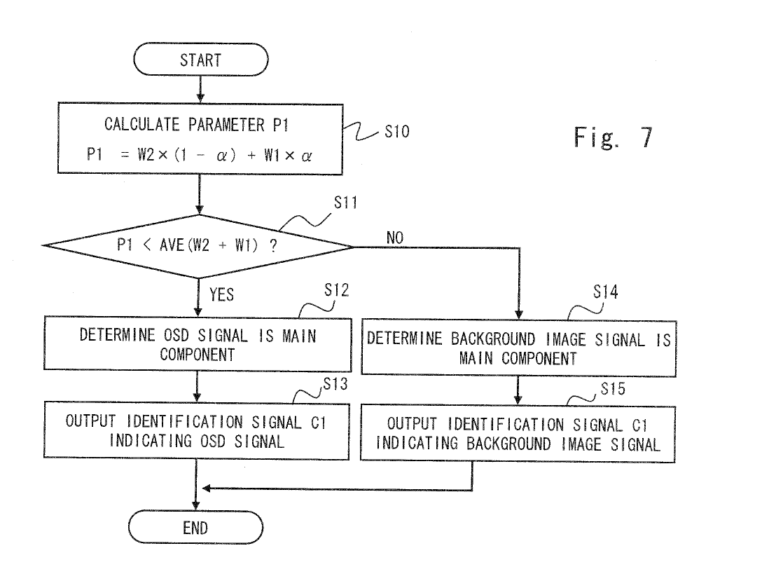

FIG. 7 is a flowchart illustrating an example of the generation procedure of the abovementioned bit precision identification signal C1 In step S10, a parameter P1 defined by the following formulas is calculated.

P1=W2×(1−alpha)+W1×alpha

As can be seen from the above formula of the parameter P1, the parameter P1 can be obtained by performing a similar calculation to the alpha blending process for bit precisions W1 and W2 of the background image signal V1 and the OSD signal V2.

In step S11, an average value of W1 and W2 is compared with the magnitude of the parameter P1. If the parameter P1 is larger than the average value (YES in step S11), the image synthesizer 100 determines that the OSD signal V2 is the main component. Then the image synthesizer 100 outputs the identification signal C1 indicating that the OSD signal V2 is the main component (steps S12 and S13).

On the other hand, if the average of W1 and W2 is larger than the parameter P1 (NO in step S11), the image synthesizer 100 determines that the background image signal V1 is the main component. Then the image synthesizer 100 outputs the identification signal C1 indicating that the background image signal V1 is the main component (steps S14 and S15).

Note that the generation procedure of FIG. 7 can also be applied to a case where three or more images are sequentially alpha-blended. By the way, as in the image 96 illustrated in FIG. 13, when a transparent synthesis is performed on only two images, the image synthesizer 100 may identify which of the background image signal V1 or the OSD signal V2 is the main component simply according to the magnitude of the alpha value. Specifically, in a case where the alpha value represents a foreground image, i.e. the opacity of the OSD signal V2, the image synthesizer 100 determines that the OSD signal V2 is the main component when the alpha value is larger than 0.5, and that the background image signal V1 is the main component when the alpha value is smaller than 0.5.

### Second Exemplary Embodiment

A bit extension apparatus 2 according to a second exemplary embodiment determines a pre-synthesis bit precision of each bit of an input image signal S1 by monitoring a change in pixel values of an input image signal.

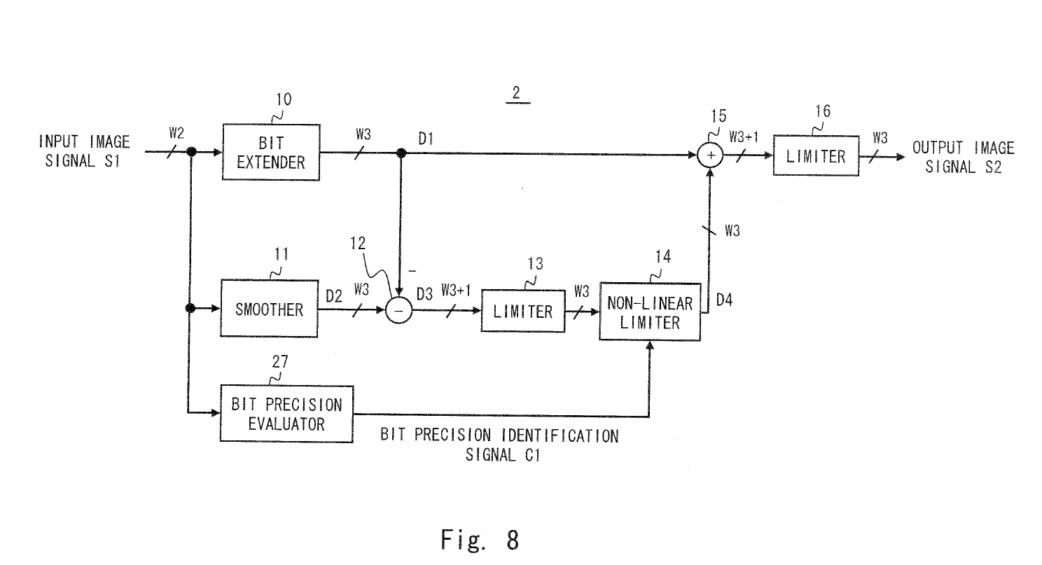

FIG. 8 is a block diagram illustrating the configuration example of the bit extension apparatus 2. In FIGS. 2A and 2B, a bit precision evaluator 27 determines the pre-synthesis bit precision of each pixel of an input image signal S1 by monitoring a change in pixel values of the input image signal S1. The bit precision evaluator 27 generates a bit precision identification signal C1 according to the evaluation result and supplies the identification signal C1 to the nonlinear limiter 14 to switch the filter characteristics. In FIGS. 2A and B, the components other than the bit precision evaluator 27 are the same as those illustrated in FIG. 1. Thus they are denoted by reference numerals identical to those in FIG. 1. Further, the explanation will not be repeated here.

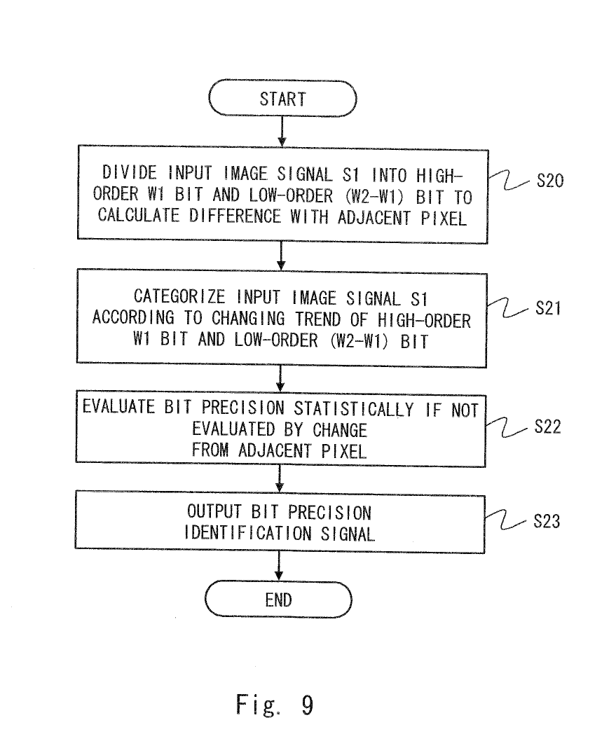

Next, the bit precision evaluation procedure by the bit precision evaluator 27 is explained hereinafter. FIG. 9 is a flowchart illustrating a specific example of the bit precision evaluation procedure. In step S20, the input image signal S1 is divided into high-order W1 bits and low-order (W2-W1) bits, and then a difference with an adjacent pixel is calculated for each of the high-order W1 bits and the low-order (W2-W1) bits, The number of bits W1 of the high-order bit group needs to be conformed to the bit precision W1 of the area B which has a lower bit precision before the image synthesis.

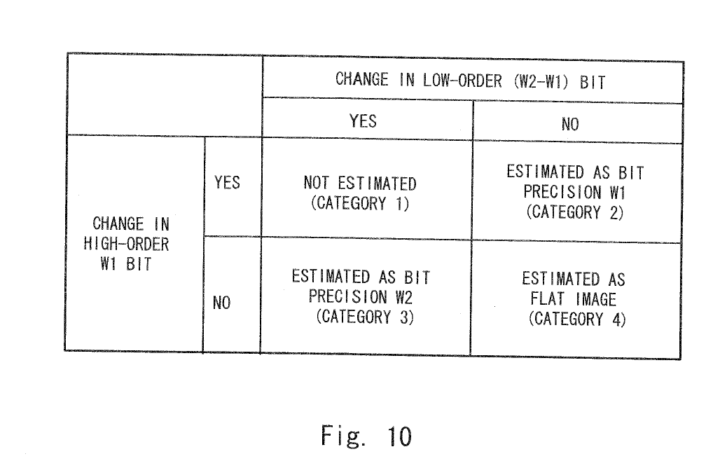

In step S21, the input image signal S1 is categorized according to the trend of the change of the high-order W bits and the low-order (W2-W1) bits. Specifically, the input image signal S1 may be categorized according to the categorization table of FIG. 10.

If there is a change in the high-order W1 bits and also in the low-order (W2-W1) bits as compared to the adjacent pixel, the bit precision evaluator 27 estimates that the bit precision cannot be determined by the bit change alone (category 1).

If there is a change in the high-order W1 bits and no change in the low-order (W2-W1) bits as compared to the adjacent pixel, the bit precision evaluator 27 estimates that the pre-synthesis bit precision of a pixel to be processed is W1 (category 2).

If there is no change in the high-order W1 bits and a change in the low-order (W2-W1) bits as compared to the adjacent pixel, the bit precision evaluator 27 estimates that the pre-synthesis bit precision of a pixel to be processed is W2 (category 3).

If there is no change in the high-order W1 bits and also no change in the low-order (W2-W1) bits as compared to the adjacent pixel, the bit precision evaluator 27 estimates that input image signal S1 is a flat image with a small gradation steps change (category 4).

If the input image signal S1 is categorized into “category 1” or “category 4” in step S21, the pre-synthesis bit precision of the image input signal S1 is statistically evaluated in step S22. A specific example of the statistical evaluation procedure is explained below.

For example, a value “−1” is assigned to a pixel which is estimated to have the bit precision W1 before the image synthesis in step S21, a value “+1” is assigned to a pixel which is estimated to have the bit precision W2, and a value “0” is assigned to a pixel which is categorized into the category 1 or 4. Then, the average value of the pixel to be processed and pixels located before and behind this pixel should be calculated. If the calculated average value is negative, the bit precision evaluator 27 estimates that the pre-synthesis bit precision is W1. If the calculated average value is positive, the bit precision evaluator 27 estimates that the pre-synthesis bit precision is W2.

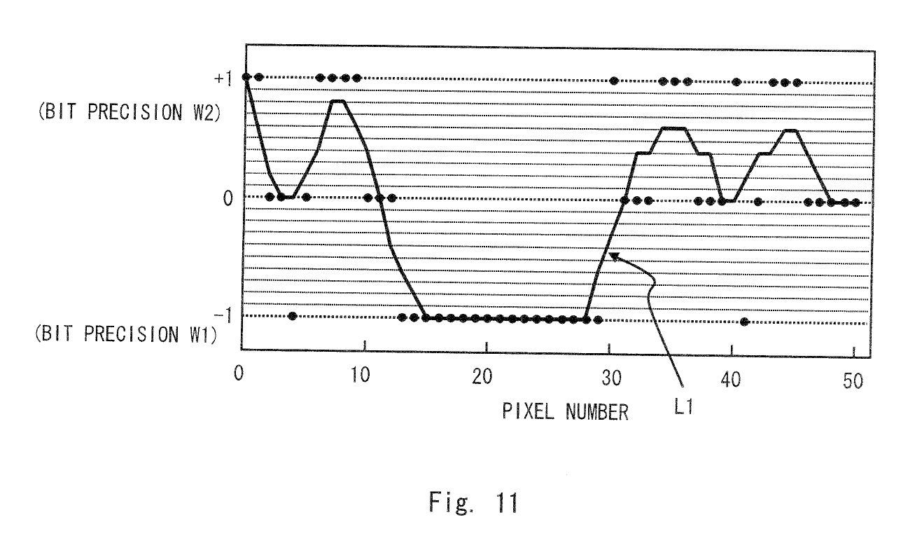

FIG. 11 is a graph plotted with the result of the categorization in step S21 to perform the statistical evaluation procedure in step S22. The dots in FIG. 11 represent the categorized result in step 521 for the respective pixels. Meanwhile, the solid line L1 in FIG. 11 represents the moving average of each pixel and two pixels before that pixel and two pixels behind that pixel, i.e., five pixels in total. For example, the pixel of the pixel number 10 is categorized as “not evaluated (category 1)” or “flat image (category 4)”, but the average value of that pixel and two pixels before that pixel and two pixels behind that pixel, i.e., five pixels in total is positive. Therefore, the pixel of the pixel number 10 is estimated to have a bit precision of W2 before the image synthesis in the statistical evaluation process in the step S23.

As mentioned above, the bit extension apparatus 2 can determine a bit precision of each pixel of the input image signal S1 by monitoring a change in pixel values of the input image signal. Further, the bit extension apparatus 2 can change the filter characteristics of the nonlinear limiter 14 according to the evaluation result of the bit precision evaluator 27. That is, the bit extension apparatus 2 can change the filter characteristics autonomously without depending on the externally-supplied bit precision identification signal C1.

By the way, the configuration of the bit extension apparatus 2 illustrated in FIG. 8 is merely an example. As described in a first exemplary embodiment, the configuration of bit extension apparatus 2 can be appropriately modified in order to increase the number of gradation steps of the input image signal S1 according to various known signal processing processes.

The first and second exemplary embodiments can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. An image processing apparatus that receives an input image signal generated by combining a plurality of image signals with different bit precisions and generates an output image signal obtained by increasing the number of gradation steps of the input image signal by bit extension, the image processing apparatus comprising:
an intermediate signal generator generating an intermediate signal according to the input image signal, the intermediate signal being used to correct the input image signal such a manner that a pixel value corresponding to a halftone increased by the bit extension is included in the output image signal; and
a nonlinear filter that performs a nonlinear process to a pixel value of the intermediate signal,
wherein the nonlinear filter changes its filter characteristic based on a pre-synthesis bit precision of a pixel that is to be processed and included in the input image signal when the nonlinear process is performed on the pixel value of the intermediate signal corresponding to the pixel to be processed.

2. The image processing apparatus according to claim 1, wherein the nonlinear filter changes the filter characteristic in response to a bit precision identification signal, the bit precision identification signal enabling to identify a difference of a pre-synthesis bit precision of each pixel included in the input image signal.

3. The image processing apparatus according to claim 2, wherein the bit precision identification signal indicates which of the plurality of image signals each pixel included in the input image signal is composed of.

4. The image processing apparatus according to claim 2, wherein the bit precision identification signal indicates a pre-synthesis bit precision of each pixel included in the input image signal.

5. The image processing apparatus according to claim 2, further comprising an image synthesizer that generates the input image signal by combining the plurality of image signals, and generates the bit precision identification signal.

6. The image processing apparatus according to claim 5, wherein the image synthesizer generates the bit precision identification signal according to an alpha value that is specified for each of the plurality of image signals in order to perform an alpha blend on the plurality of image signals.

7. The image processing apparatus according to claim 1, further comprising:
a bit precision evaluator dividing a pixel value of each pixel included in the input image signal into a high-order bit group and a low-order bit group, comparing each a high-order bit group and a low-order bit group between a process target pixel and a adjacent pixel around the process target pixel, and generating the bit precision identification signal according to an existence of a change in the high-order bit group and an existence of a change in the low-order bit group,
wherein the high-order bit group corresponds to a bit precision of a first image signal, the first image signal being included in the plurality of image signals and having a relatively low bit precision, and
the low-order bit group corresponds to a difference between the bit precision of the first image signal and a bit precision of a second image signal, the second image signal being included in the plurality of image signals and having relatively high bit precision.

8. The image processing apparatus according to claim 1, wherein the intermediate signal generator uses a smoothed signal obtained by smoothing the input image signal or a differential signal obtained by performing a subtraction process between the smoothed signal and the input image signal as the intermediate signal.

9. An image processing apparatus comprising:
a smoother generating a smoothed signal by smoothing an input image signal, the input image signal generated by combining a plurality of image signals with different bit precisions;
a bit extender extending a bit width of the input image signal;
a subtractor performing a subtraction process between the input image signal whose bits are extended by the bit extender and the smoothed signal in order to generate a differential signal;
a non-linear filter performing a nonlinear process on a pixel value of the differential signal; and
an adder adding one of two signals on which the subtraction process was performed and the differential signal on which the nonlinear process was performed in order to generate an output image signal,
wherein the nonlinear filter changes its filter characteristic based on a pre-synthesis bit precision of a process target pixel included in the input image signal when the nonlinear process is performed on the pixel value of the differential signal corresponding to the process target pixel.

10. The image processing apparatus according to claim 9, wherein the nonlinear filter changes the filter characteristic in response to a bit precision identification signal, the bit precision identification signal enabling to identify a difference of a bit precision for each pixel of the input image signal.

11. The image processing apparatus according to claim 10, wherein the bit precision identification signal indicates which of the plurality of image signals is a main component of each pixel of the input image signal.

12. The image processing apparatus according to claim 10, wherein the bit precision identification signal indicates a pre-synthesis bit precision of each pixel included in the input image signal.

13. The image processing apparatus according to claim 10, further comprising an image synthesizer generating the input image signal by combining the plurality of image signals, and generating the bit precision identification signal.

14. The image processing apparatus according to claim 13, wherein the image synthesizer generates the bit precision identification signal according to an alpha value, the alpha value specified for each of the plurality of image signals in order to perform an alpha blend on the plurality of image signals.

15. The image processing apparatus according to claim 9, further comprising:
a bit precision e valuator dividing a pixel value of each pixel included in the input image signal into a high-order bit group and a low-order bit group, comparing each a high-order bit group and a low-order bit group between a process target pixel and a adjacent pixel around the process target pixel, and generating the bit precision identification signal according to an existence of a change in the high-order bit group and an existence of a change in the low-order bit group,
wherein the high-order bit group corresponds to a bit precision of a first image signal, the first image signal being included in the plurality of image signals and having a relatively low bit precision, and
the low-order bit group corresponds to a difference between the bit precision of the first image signal and a bit precision of a second image signal, the second image signal being included in the plurality of image signals and having relatively high bit precision.

16. A method for receiving an input image signal generated by combining a plurality of image signals with different precisions and generating an output image signal obtained by increasing the number of gradation steps of the input image signal by bit extension, the method comprising:
generating an intermediate signal used to correct the input image signal such a manner that a pixel value corresponding to a halftone increased by the bit extension is included in the output image signal; and
applying a nonlinear filtering to a pixel value of the intermediate signal corresponding to a pixel that is to be processed and included in the input image signal,
wherein a characteristic of the nonlinear filtering is determined according to a pre-synthesis bit precision of the pixel to be processed.

17. The method according to claim 16, wherein the characteristic of the non-linear filtering is determined according to an alpha value, the alpha value specified for each of the plurality of image signals in order to perform an alpha blend on the plurality of image signals.
